(19) United States
(12) Patent Application Publication
(10) Pub. No.: US 2009/0100037 A1
(43) Pub. Date: Apr. 16, 2009

(54) SUGGESTIVE MEETING POINTS BASED ON LOCATION OF MULTIPLE USERS

(75) Inventor: Bernd SCHEIBE, Hamburg (DE)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/872,494

(22) Filed: Oct. 15, 2007

(51) Int. Cl. G06F 17/30

(52) U.S. Cl. 707/5; 707/E17.014

(57) ABSTRACT

A system, method, and computer readable medium are provided for suggesting meeting locations to multiple users based, at least in part, on their current locations. In one example, a method includes receiving location information associated with at least two users, determining a center location with respect to the received location information, causing a search for a meeting location based on the determined center location, and causing communication of the meeting location(s) to at least one of the users. The method may further include receiving search criteria, where the search includes searching point-of-interest locations based on the center location and filtering the search results based on the search criteria. The method may further include receiving or using additional context information in addition to location information, such as time of day, day of the week, traffic conditions, weather conditions, and the like, to filter or order the search results.

### BACKGROUND

1. Field

The present invention relates generally to location based applications and services based upon the context of a user or user device, and in one example, to suggesting potential meeting locations based on the location of multiple users.

2. Related Art

Mobile devices, such as mobile phones, are becoming ever more prevalent and increasingly capable of determining the context of the environment in which they are used. For example, location services and applications may be used to supply information or services to a user's mobile device based on determined location information of the mobile device, e.g., via GSM network cell ID, Enhanced Observed Time Different (EOTD)-based location, Global Position System (GPS), and other location technologies. For instance, a location based application may display a map of a mobile device's determined location and provide an indication of one or more point-of-interest locations (such as a business, a tourist attraction, a person, e.g., a member of a user's social network, or the like) within a given geographical region. As an illustrative example, a user may request to search and locate nearby restaurants from a location service, the user device receiving and displaying a map (or textual listing) of nearby restaurants from the location service.

In another illustrative example, a user may request to search and locate friends or social contacts that may be nearby. For example, a friend finder application, such as www.mobiloco.de, generally operates to display (via a map and/or textual listing) the location and/or distance of a user to his/her friends. The application might display a map having a predefined radius (e.g., 1 mile) and display the position and distance to friends known to be within the predefined range from the user. If the friends want to meet, however, they have to contact each other and agree on where to meet, which may take considerable time and effort to coordinate.

### BRIEF SUMMARY

According to one aspect of the present invention a computer implemented method for suggesting one or more meeting locations based on the location of multiple users is provided. In one example, the method includes determining location information associated with at least two users, determining a center location with respect to the location information of the users, causing a search for locations based on the determined center location, and causing communication of the location(s) to at least one of the users.

In another example, a method includes receiving a search request for a meeting location from a first user device, receiving location information associated with the first user and at least a second user, causing a search for a meeting location based on the search request and location information of the first and at least second user, and causing communication of the meeting location to at least one of first and at least second user devices.

The methods may further include receiving search criteria for the meeting location such as a desire to meet at a particular type of location (e.g., a restaurant, bar, park, museum, and the like). The search may include searching point-of-interest locations based on the center location (e.g., searching within a geographical region around a center location or ordering search results based on proximity thereto) and filtering the search results based on the search criteria. The methods may further include receiving or using additional context information in addition to location information, such as time of day, day of the week, traffic conditions, weather conditions, and the like, to adjust the center location and filter or order the search results.

The methods may further include communicating a map to the at least one user, the map associated with the meeting location(s). For example, a map may display the suggested meeting location(s) as well as the user's position. Further, directions to the meeting location(s) may be communicated to one or more of the users.

The various aspects and examples of the present invention are better understood upon consideration of the detailed description below in conjunction with the accompanying drawings and claims.

### BRIEF DESCRIPTION OF THE DRAWINGS

FIG. 1 illustrates an exemplary client-server architecture and environment in which some aspects and examples described may by used;

FIGS. 2A and 2B illustrate exemplary information flows between a server and a user device according to one example;

FIGS. 3A and 3B illustrate exemplary displays of suggested meeting locations for a user device according to one example;

FIG. 4 illustrates an exemplary method for responding to a request for suggestions of meeting locations according to one example; and

FIG. 5 illustrates an exemplary computing system that may be employed to implement processing functionality for various aspects of the invention.

### DETAILED DESCRIPTION

The following description is presented to enable a person of ordinary skill in the art to make and use the various aspects and examples of the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Broadly speaking, and in one example, an exemplary method for suggesting locations for a plurality of users to meet includes determining the relative locations of the users, and generating a list of locations to meet based on the relative locations. The list of suggestions may be generated based on determining a center location or region relative to the users (which can, but does not need to be an exact geographical center of the users) and searching locations, e.g., point-of-interest locations, around the center location. Various algorithms and methods may be used for determining a geographical center location and searching for locations.

Additionally, the center location and search of locations may be based or filtered on additional criteria such as a user request (e.g., a request for a restaurant or park), user ratings, context information such as operating hours, current traffic conditions, travel times, time of the day, day of the week, available/preferred transportation methods, and other factors that may influence the list of locations returned to the users. The results may be communicated to one or more of the multiple users as a textual listing identifying locations (and may include the distance and directions thereto), or may be returned with a map displaying the user's current location and suggested meeting locations.

In some examples described herein, a server system is provided for providing a listing of suggestions for meeting places based upon context of a plurality of users (e.g., the context including the location, time, date, and so on). For example, the server may include interface logic for receiving context information from or associated with a user (e.g., the user or user device), as well as a request for a meeting location and any search criteria associated with the request or user. The server may include logic for associating information or services with the request, e.g., search results of point-of-interest locations around a center location associated with the multiple users, maps, driving directions, advertisements, or the like. The server further operable to communicate (or at least initiate the communication of) the associated information or service to the one or more users.

It is noted that as used herein, the term “point-of-interest” (or “POI”) refers to any fixed or dynamic location which may be described as a geographical location or depicted in a map interface, and may correspond, for example and without limitation, to a business establishment, a tourist attraction, a landmark, a person or other entity, user-generated content (e.g., comments or reviews of particular location or establishment, etc.), user associated location (e.g., private locations/events), public events, a geocache, coupons, local promotions, etc.

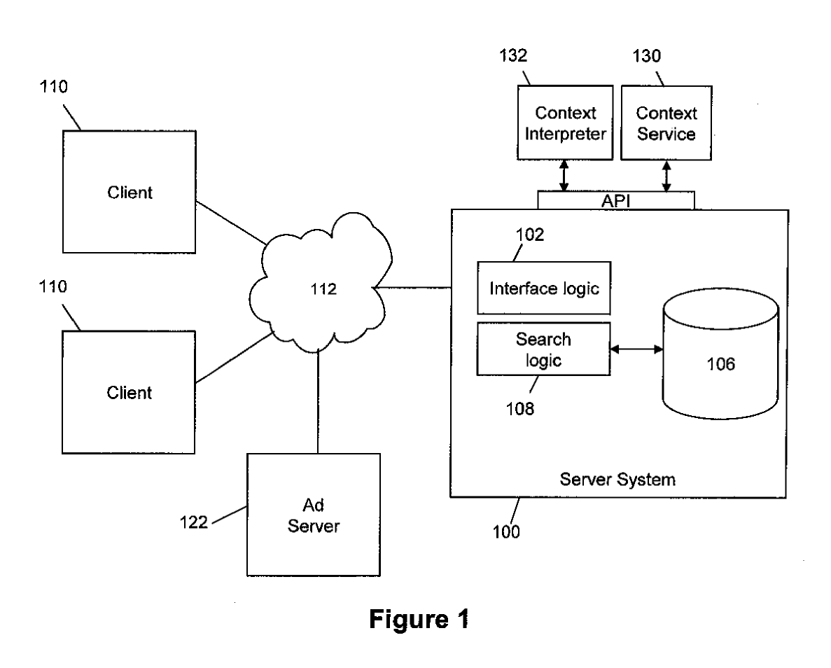

Initially, and with reference to FIG. 1, an exemplary environment is described in which some examples of the exemplary systems and methods for suggesting meeting locations may be used. In particular, FIG. 1 illustrates a client-server system in which one or more client devices 110 may communicate with a server system 100 via network 112. Server system 100, which may include one or more server devices, generally includes interface logic 102 for interfacing with network 112, and search logic 108 for searching and associating information or services (e.g., a listing of potential meeting locations, maps, and so on) to one or more client devices 110 based, at least in part, on received context information (e.g., including location information, time, date, etc.) from one or more client devices 110. Server system 100 may further include a database 106 for storing information including, for example, POI location information, map information, context information, and information or services for associating with data based on received context and request criteria information. As will be described, database 106 may be stored locally with server system 100 or remotely to server system 100.

Context information may include one or more of location information, time, ambient conditions, device or user ID, device type, user profile information, Personal Management Information (PIM), and the like. In one example, client device 110 may generate geographical location information (e.g., from a GPS location device, cell identification, or other location technologies), which is communicated to server system 100 with a request for suggested meeting locations. The context information may be communicated to server system 100 by client device 110 or from another device. For example, a cell ID might be determined by a wireless server and transmitted to server system 100 for determining the location information, where the context is not generated directly by the user device (nor is the context information communicated from the client device 110). Additionally or alternatively, a user may manually enter geographical location; for example, in instances where the device is not capable of generating location information or the user wishes to input a geographical location different than their current location.

Client devices 110 and server system 100 may include suitable communication interfaces to communicate in part or in whole via network 112. Network 112 may include a Wide Area Network (WAN) such as the Internet, a wireless network, such as a wireless gateway, e.g., a cellular, satellite, or other wireless network, a non-wireless network such as a cable or fiber optic network, or a combination of wireless and non-wireless systems. Client devices 110 and server system 100 may communicate, in part or in whole, via wireless or hardwired communications, such as Ethernet, IEEE 802.11b wireless, or the like. Additionally, communication between client devices 110 and server system 100 may include (or access) various servers such as a map server, mobile server, media server, mail server, and the like. Client devices 110 for use with server system 100 may include a typical web browser application, a wireless application protocol (WAP) feature, or other data communication protocol associated with the device of client devices 110 suitable to communicate with server system 100.

In this example, server system 100 includes interface logic 102 for receiving context information (including location information), request criteria, user-input, and the like. To that end, server system 100 may utilize various wireless or Web data interface techniques such as Common Gateway Interface (CGI) protocol and associated applications (or “scripts”), Java® “servlets”, i.e., Java® applications running on a wireless server, Web server, or the like to present information and receive input from client devices 110. It will be appreciated that server system 100, although described herein in the singular, may actually comprise plural computers, devices, backends, and the like, communicating (wired and/or wireless) and cooperating to perform some or all of the functions described herein. Additionally, server system 100 may be implemented in various fashions and include various hardware, software, or firmware to carry out the examples described herein.

Search logic 108 generally operates to search (or at least cause the search of) and associate information (e.g., POI location information, maps, advertisements, directions, and so on) with information received from or associated with a client device 110. For example, information may be searched locally, e.g., within database 106, and/or remotely, e.g., with a context-based service 130 as described below, based on received context information and user request criteria. Search logic 108 may further be operable to order and/or filter search results based on received search criteria, relative locations of the users, proximity of the POI locations to the center location, and so on.

Server system 100 may thereafter transfer (or initiate/direct the transfer of, e.g., via advertisement server 122) information to one or more client devices 110 (which may or may not include the particular client device 110 associated with the information received by server system 100). Additionally, server system 100 may include various other components known in the art, e.g., a scripting engine (such as a PHP scripting engine, which may include authentication logic, upload logic, metadata processing logic, permissions handling logic, and so on).

Alternatively or in additional to search logic 108 causing a search of local database 106, a portion or all of the received context information, request criteria, and so on may be communicated to a remote or third party service provider or server system, e.g., a map and/or search server system, mobile phone service provider, advertisement server, and so on, which may in turn communicate associated information with one or more client devices 110 or provide one or more client devices 110 access to such information. For example, server system 100 may communicate information to one or more of a context interpreter 132 and context-based service 130, e.g., via one or more Application Program Interfaces (API), as shown. In one such example, server system 100 may communicate context information to a context interpreter 132; for example, communicating raw location information such as mobile cell ID, GPS information, or wireless access point location, and queries context interpreter 132 for city and street information. Additionally, received context information may include and relate to the date, time of day, ambient conditions, information related to a Personal Management Information (PIM) application or service, or combinations thereof, which may be determined or modified by context interpreter 130. The information processed by context interpreter 130 is in turn communicated to server system 100, and may be communicated to a context-based service 130.

Context-based service 132 may include various servers and services, e.g., a search server (e.g., for searching POI information), map server, or the like, operable to service requests for meeting places by client devices 110. For example, the location information of multiple users and/or a determined center location, search criteria, and so on may be communicated to context-based service 132 including a search server for searching geographical POI locations and ordering the POI locations based on the search criteria. It is noted that in other examples, client device 110 may be capable of providing more complete context information, which does not require the use of a context interpreter 130, or alternatively, context-based service 132 may include or access a context interpreter directly.

FIG. 1 further illustrates an advertisement server 122, which may communicate through network 112 with one or more client devices 110 and/or to server system 100. Advertisement server 122 may operate to associate advertisements with user-generated requests and/or responses or meeting locations for transmission to a client device 110. For example, an advertisement may be associated with a response to client device 110 based on the listing of meeting location, an inputted search request, the city or area being searched, and the like. In one example, advertisement server 110 communicates with server system 100 and transmits advertisement data thereto, for example, in response to input from client device 110. Server system 100 may transmit the advertisement data with a response or display of a meeting location to client device 110. In other examples, advertisement server 110 may send the advertisement data directly to client device 110 based on information from server system 100 and/or client device 110. It will be appreciated that server system 100 and advertisement server 122 are illustrated as separate items for illustrative purposes only; in other examples, they may be included in a common server device or system (e.g., backend or service provider).

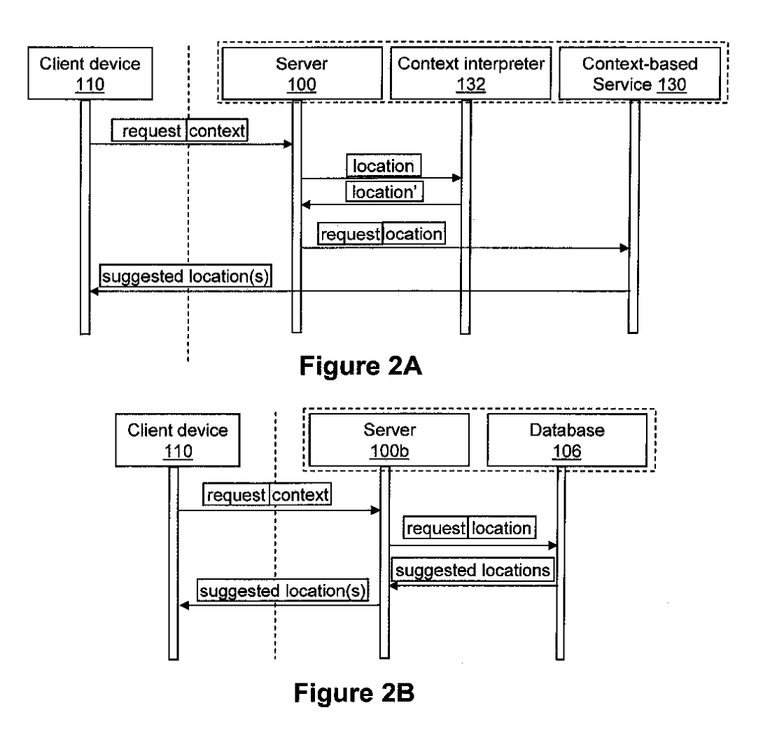

FIGS. 2A and 2B illustrate and contrast exemplary flows of information between exemplary servers 100, 100b and client device 110 according to two examples. In particular, FIG. 2A illustrates the flow of data between server system 100, context interpreter 132, and context-based service 130, all of which may be included as separate server systems or within a common associated server system, e.g., a common backend.

The flow of information is generally as described with respect to FIG. 1; for example, location information as well as any other context information and search criteria are received by server system 100. In one example, the location information may be interpreted by interpreter 132 and the interpreted location communicated to the context based service 130. Context-based service 130 may include a search server and map server for searching POI locations based on the received location information of the users (e.g., based on the multiple locations or center location) and generating a list of meeting locations and associated maps. The listing of meeting places and maps may be transferred to server system 100 and thereafter transferred or accessible to one or more users or user devices including, for example, client device 110. Additionally, context-based service 132 may communicate a list of meeting places, maps, etc., directly to client device 110 or a different device.

In contrast, FIG. 2B illustrates the flow of data between client device 110 and server system 100b, where server system 100b includes logic to carry out functions similar or identical to context interpreter 132, and context-based service 130 of FIG. 2A (or operates without such functions). Server system 100b may include interface logic for receiving data and context and search logic for searching and associating information (e.g., POI locations, maps, and so on from database 106). In both examples, server system 100 and 100b may include interface logic for receiving or determining location information from multiple users, causing a generation of a list of potential meeting locations based on the relative location of the users (e.g., based on geographical center location), and causing at least one of the meeting locations to be communicated to client device 110.

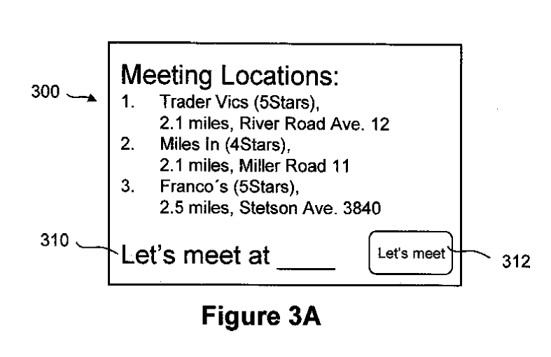

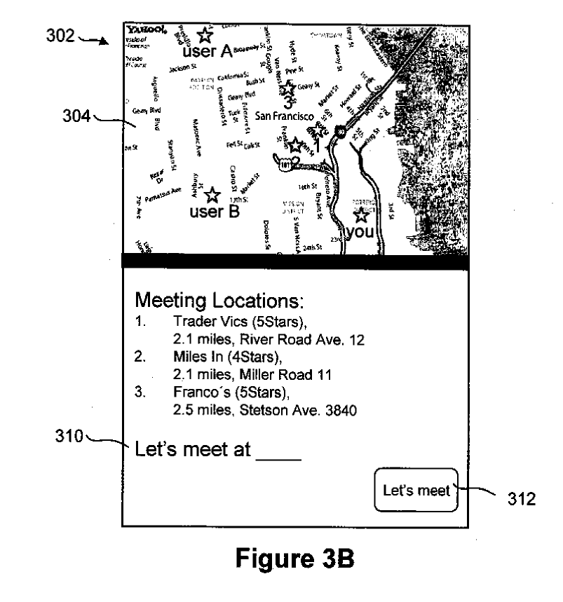

FIGS. 3A and 3B illustrate exemplary displays 300 and 302 for displaying suggestions for meeting locations. It is noted that the request may be made via a client device accessing a dedicated webpage or application, as a feature included with a communication application such as with an Instant Message (IM) or chat application interface (e.g., as a button), text messaging or Short Message Service (SMS), VoIP application interface, on-line dating or social communication applications, and the like. In other examples, a request for meeting locations may be made via email, text messaging or SMS, or the like, and a response communicated to a user device in a similar or dissimilar fashion as the request.

Display 300 illustrates a textual listing of suggested meeting locations, including the name of the location, distance from the user's location, ratings, and address (of course, more or less information may be displayed). In this example, the search results of suggested meeting locations are ranked or ordered based initially on distance from a center location and then by ratings (of course, other ranking and ordering systems are possible). Additionally, display 300 may include a field 310 for inputting one of the meeting locations (e.g., 1, 2, or 3), for communication to the other users. In one example, a selection button 312 may be included for communicating the selection. It will be appreciated that a selection of a meeting location may be made by any suitable means, e.g., inputting or keying the number 1 on a device keypad, highlighting a selection and selecting via arrow keys, and so on.

Additionally, in one example, users may vote on suggested meeting location, e.g., via field 310, selection button 312, or highlighting and selecting one of the suggestions. A group of users may each vote on one of the displayed meeting locations via display 300, the winning location communicated to the other users as the meeting location. A server device, for example, may receive selections and determine a winning location, the winning location communicated to all users. It will be appreciated that any suitable voting algorithm may be used to determine a winner and communicate the winner to other users.

Display 302 illustrates an exemplary display that includes a map 304 illustrating the returned meeting location suggestions. The suggested locations may include numbers or names overlaid on the map (shown here as starred numbers on the map). Further, the relative location of the users (e.g., “you”, “User A”, and “User B”) is displayed on map 304. A user may make a selection for communication to the other users as described above. In one example, a listing may be displayed in addition to map 304, e.g., as shown in the lower portion of display 302, where selections may be made from the list with reference to the displayed map 304.

Various other manners for displaying potential meeting locations are possible and may further depend on the capabilities of the user device. Further, other features such as driving directions, user comments or reviews, links to websites, coupons, phone numbers, contact information of the other users, advertisements, and the like may be displayed with the suggested location.

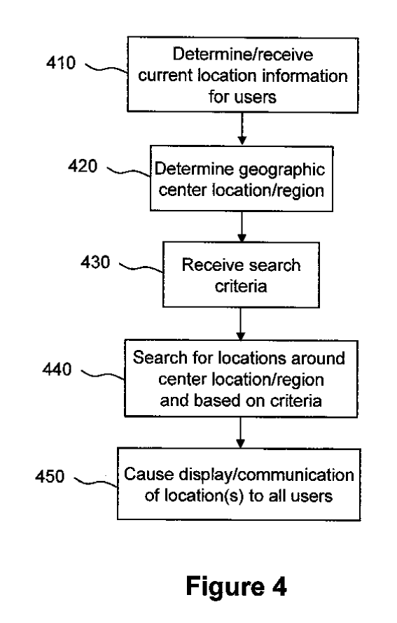

FIG. 4 illustrates an exemplary method for servicing a request for a suggested meeting location for a plurality of users. The method includes receiving or determining current location information for a plurality of users at 410. In one example, a server device may receive the identity of a plurality of users and location information for each. As described herein, the location information may be raw data, e.g., GPS coordinates or cell-ID, which may be translated or converted to a city and street address remotely or locally. Further, the location information may be received directly from the client devices or from another device, e.g., from a mobile server.

The exemplary method further includes determining a geographic center location or region at 420 (which may be performed before or after location information is translated into city and street addresses, if performed). Any suitable algorithm may be used to determine a center location from the location data of the plurality of users. In one example, the subsequent search results may be ordered based on their distance from the center location. In other examples, a radius may be taken around the center location (which may depend on various factors such as the disbursement of the users, the number of POI locations returned, and so on) and searched for best fits therein. It will be appreciated that alternative and additional algorithms and methods for determining a center location and searching and filtering based on a center location can be used.

In some examples, the method further includes receiving search criteria at 430. For example, the search criteria may include a request for a particular type or kind of desired meeting location, such as a restaurant, coffee shop, bar, park, or the like. Thus, a search for meeting locations can be filtered according to search criteria, if received.

The method further includes searches POI locations based on the center location/region at 440 (or at least based on the relative position of the users). As described, the search may be performed with a general search, ranked or ordered based on a center location, and filtered based on the search criteria. Additionally, the search results and/or the center location determination may be influenced by other contextual information such as the time of day, day of the week, traffic conditions, weather conditions, and the like. For example, at certain times of the day, parts of a city may take longer to traverse due to traffic, certain POI locations such as a library or museum may be closed at certain times/days of the week, and so on.

The method further includes causing the display of at least one of the returned locations to a user at 450. In one example, the list is communicated to all of the users for display and one or more of the users may make a selection from the list, the selection communicated to the other users. Further, various other information, such as maps, driving directions, advertisements, and so on may be communicated to the users in series or in parallel to the suggested locations.

It will be appreciated that the method may be carried out in various orders and some of the recited features omitted. For example, the location and search criteria may be received in other orders or simultaneously. Further, the exemplary method may receive only the center location of the multiple users (and not the individual users location), or the method may perform the search based on relative user positions without determining or receiving a center location. Various other modifications to the described method will be apparent to one of ordinary skill in the art.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

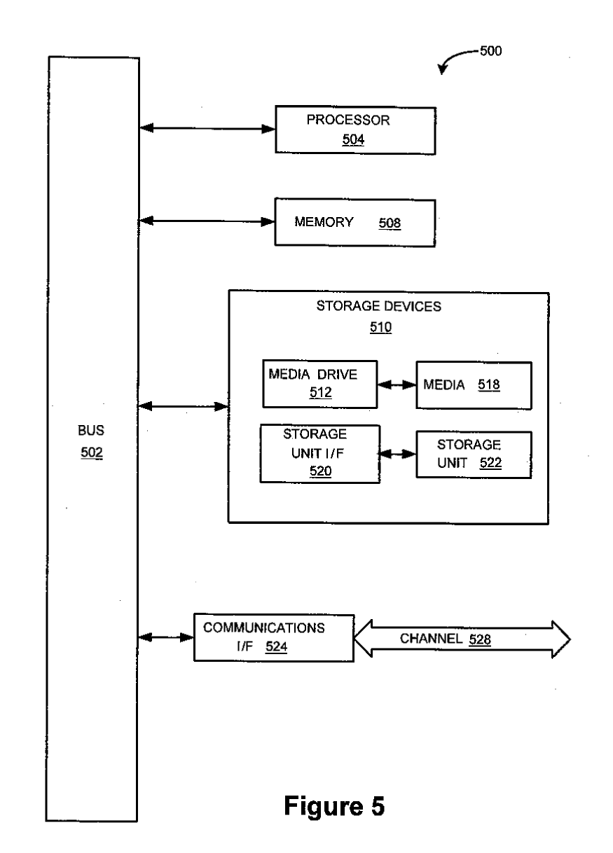

FIG. 5 illustrates an exemplary computing system 500 that may be employed to implement processing functionality for various aspects of the invention (e.g., as a client device or a server device). Those skilled in the relevant art will also recognize how to implement the invention using other computer systems or architectures. Computing system 500 may represent, for example, a desktop, laptop or notebook computer, hand-held computing device (PDA, cell phone, smart phone, and the like), mainframe, server, client, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, preferably random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, storage unit 522, or signal(s) on channel 528. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A computer-implemented method for suggesting a meeting location for a plurality of users, the method comprising:
receiving location information associated with at least two users;
determining a center location with respect to the received location information;
causing a search for a meeting location based on the determined center location; and
causing communication of the meeting location to at least one of the at least two users.

2. The method of claim 1, further comprising receiving search criteria, the search further based on the search criteria.

3. The method of claim 1, wherein causing a search comprises causing a search for point-of-interest locations based on the center location and filtering the search results based on at least one search criteria.

4. The method of claim 1, wherein causing a search comprises causing a search for point-of-interest locations based on the center location and ordering the search results based on distance to the center location.

5. The method of claim 1, further comprising receiving additional context information other than location, and filtering the search results based on the additional context information.

6. The method of claim 1, wherein multiple meeting locations are communicated to the at least two user devices.

7. The method of claim 1, further comprising communicating a map to the at least one user, the map associated with the meeting location.

8. The method of claim 1, further comprising determining the center location based on travel speed of each of the multiple users.

9. The method of claim 1, further comprising causing communication of a first set of meeting locations to at least two users; receiving a selection of one of the set of meeting locations from at least one user and causing communication of a winning location to the at least two users based thereon.

10. A computer-implemented method for suggesting a meeting location for a plurality of users, the method comprising:
receiving a search request for a meeting location from a first user device;
receiving location information associated with the first user device and at least a second user device;
causing a search for a meeting location based on the search request and location information of the first and at least second user devices; and
causing communication of the meeting location to at least one of the first and at least second user devices.

11. The method of claim 10, further comprising receiving search criteria for the meeting location, the search further based on the search criteria.

12. The method of claim 10, wherein causing a search comprises causing a search for point-of-interest locations based on the center location and filtering the search results based on at least one search criteria.

13. The method of claim 10, wherein causing a search comprises causing a search for point-of-interest locations based on the center location and ordering the search results based on distance to the center location.

14. The method of claim 10, further comprising receiving additional context information other than location, and filtering the search results based on the additional context information.

15. The method of claim 10, further comprising communicating a map to the at least one user, the map associated with the meeting location.

16. An apparatus for identifying a location based upon location information of multiple users, the apparatus comprising:
logic for receiving location information associated with multiple users;
logic for causing a search for a meeting location based on the location information of the multiple users; and
causing communication of the meeting location to at least one of the users.

17. The apparatus of claim 16, further comprising logic for determining a center location with respect the location information associated with the multiple users, wherein the search is based on the center location.

18. The apparatus of claim 16, further comprising logic for receiving at least one search criteria for the meeting location, the search further based on the received search criteria.

19. A computer-readable medium encoded with computer program instructions for performing a process, the process comprising:
receiving location information associated with at least two users;
determining a center location with respect to the received location information;
causing a search for a meeting location based on the determined center location; and
causing communication of the meeting location to at least one of the at least two users.

20. The computer-readable medium of claim 19, wherein the process further comprises receiving search criteria for the meeting location.

21. The computer-readable medium of claim 19, wherein causing a search comprises causing a search for point-of-interest locations based on the center location and filtering the search results based on at least one search criteria.

22. The computer-readable medium of claim 19, wherein causing a search comprises causing a search for point-of-interest locations based on the center location and ordering the search results based on distance to the center location.

23. The computer-readable medium of claim 19, wherein the process further comprises receiving additional context information other than location, and filtering the search results based on the additional context information.

24. The computer-readable medium of claim 19, wherein multiple meeting locations are communicated to the at least two user devices.

25. The computer-readable medium of claim 19, wherein the process further comprises communicating a map to the at least one user, the map associated with the meeting location.
